(19) United States
(12) Patent Application Publication
(10) Pub. No.: US 2001/0056473 A1
(43) Pub. Date: Dec. 27, 2001

(54) Information retrieval system and method

(76) Inventors: Kenneth Arneson, Seattle, WA (US); John Clark, Seattle, WA (US); Lawrence J. Corvari, Normandy Park, WA (US)

Correspondence Address: MANELLI DENISON & SELTER PLLC, 7th Floor, 2000 M Street, N.W., Washington, DC, 20036-3307, US

(21) Appl. No.: 09/852,848

(22) Filed: May 11, 2001

Related U.S. Application Data
(60) Provisional application No. 60/131,072, filed on Apr. 26, 1999.
(60) Provisional application No. 60/204,042, filed on May 12, 2000.

(51) Int. Cl. G06F 15/16

(52) U.S. Cl. 709/217

(57) ABSTRACT

A system and method for retrieving information from the Internet with a digital text messaging capable phone. The system includes a retrieval computer, a plurality of user computers, and a plurality of content server computers interconnected via a communications medium, which includes the Internet. A user registers with the system and stipulates the information that they desire to remotely retrieve and provide the phone number of the cellular phone to which they wish the information to be provided. A user calls a phone number corresponding to the information that they wish to retrieve. The system employs a caller ID procedure to identify the caller and extracts the information from the content server maintaining the information. The system then sends a text message containing the information to the user's cellular phone. The system is adapted to provide the information retrieval at no incremental cost to the user.

This application claims the benefit of priority under 35 U.S.C. § 119(e) of U.S. Provisional Application No. 60/131,072, filed Apr. 26, 1999, which is herewith incorporated by reference.

### BACKGROUND OF THE INVENTION

1. Field of the Invention

This invention relates generally to the field of information retrieval. More particularly, the invention relates to a system and method for remotely retrieving information from distant databases via text messaging capable cellular phones.

2. Background of Related Art

Use of on-line services, such as, electronic mail (“e-mail”), stock pricing reports, auction services, weather reports, and the like, has increased dramatically. Fueling this dramatic increase in the usage of online computer services is the emergence of the Internet and, more specifically, the World Wide Web (“WWW”) or the Web. The ease with which a user can locate and utilize resources on the Internet has enabled the Web to emerge as a viable and attractive medium for vendors to offer their services on-line. Typically, a vendor maintains a server hosting a web site or other resources, which is a location on the Internet, through which their on-line services may be accessed and utilized.

A user of a vendor's on-line services typically employs a computer connected to the Internet and Web browser software to navigate and access the vendor's computer and the resources stored thereon. For example, the user may access and utilize a particular vendor's e-mail messaging service. The user registers with the service and can then send and receive messages through the e-mail services offered by the particular vendor. Subsequently, e-mail messages addressed to the user will be received and temporarily stored on the vendor's computer. The user can then use his computer to connect to the vendor's computer and determine if any new messages have arrived, view any new messages, and create and send new messages. However, as previously noted, the user must be typically be connected to the service via a computer and thus, the on-line services of the vendor are generally not accessible without the computer and/or terminal the user uses to connect to the Internet.

Cellular phones are another technological innovation coming into increasingly common usage. Cellular phones employ duplex radiotelephony to enable portable handheld cell phone units to communicate with each other and landline telephone systems. The handheld units are typically battery powered and communicate with an interlocking network of radio repeaters or “cells” that enable the handheld units to maintain communication over large geographical areas without employing powerful radio transceivers. A typical cell phone has a range of approximately 2 miles and thus the “cell” repeater stations are typically placed approximately 3 miles apart. A cellular network automatically monitors an active cell phone and “hands off” or switches a cell phone among the various cells to maintain communication between the cellular phone and the rest of the communications network.

Cellular phones and networks are increasingly capable of communicating in a digital format. Digital communication, as opposed to analog formats, offers advantages in signal clarity, channel density within a given RF band, and more secure communications. An additional advantage of digital communication over analog is the relatively easy inclusion of text data in addition to voice signals within communication signals. The ability to receive text messages is typically realized in text messaging capable cell phones via a short messaging service (SMS). SMS is a known system and method of delivering short text messages, generally of 80 to 240 alphanumeric characters, to handheld, text capable devices via digital wireless telephony.

Because of the large number of cell repeaters needed to cover a large geographical area and the sophisticated switching and routing networks needed to handle the multitude of simultaneous calls occurring within a given network, cellular networks require a significant capital investment in communication infrastructure and an ongoing expense to maintain and administer the service. To cover these expenses and provide the profit necessary to a successful business, cellular networks typically charge a flat fee for access to their system and a per minute fee for usage of the system. Thus, a customer will pay a set fee to have cellular access, but will also pay a marginal fee for each use of the service which is proportional to the duration of each call.

Portable, laptop computers can be connected to a cell phone via a modem to enable a person to access Internet based resources in a portable manner. However, this method of accessing information and services has some significant disadvantages. A typical portable laptop computer is approximately 12″×8″×3″ and weighs on the order of 6 pounds. While portable, it can be appreciated that such a computer is too bulky and heavy to be readily carried on one's person. Both cellular phones and laptop computers typically are battery powered when being used in a portable manner. Typical batteries offer on the order of 2 to 3 hours of continuous use. Thus, a user is limited to the useful life of the shortest duration battery in the cell phone or the laptop for continuous access to the Internet. Additional batteries can be provided, however that would incur additional expense and weight, thereby reducing the convenience of such a method of accessing the Internet in a portable manner.

To preserve battery life, a user can alternatively launch the laptop and connect the cell phone each time they want to extract information from the Internet and shut them off when they finish. However, launching the laptop, initializing a connection to the Internet and starting a web browser program often consumes several minutes of time making it inconvenient to retrieve information in this manner, particularly discrete, limited amounts of information.

One aspect of the cellular phone/laptop combination of accessing the Internet that bears consideration is that such a system is overkill for many services that a user may wish to access. A laptop computer and modem connection is capable of providing full color video and audio. The display monitor, processor, harddisk, and associated batteries are configured to support these features. However, many Web based resources such as stock quotations, weather summaries, horoscopes, e-mail messaging, and the like can be presented as text only files and do not necessarily require the full facilities of a computer to receive and display.

From the foregoing, it can be appreciated that there exists an ongoing need for a system of retrieving textual information from Internet based resources, without requiring a computer. The system should be fully portable and it would be an advantage for the system to be of a size and weight so as to be readily carried on the person. The system should also provide the information in as inexpensive a manner as possible and in a timely manner in response to a request.

### SUMMARY OF THE INVENTION

The aforementioned needs are satisfied by the present invention which, in one aspect, extends Internet based services and features to devices beyond a consumer's personal computer. In one embodiment, a consumer is provided with information from a Web site via a message sent to his communications device, such as a wireless digital phone.

In one aspect, the invention comprises a system for delivering information to a plurality of recipients having mobile communications devices capable of receiving digitally encoded text messages. The system comprises at least one process server, at least one memory that has (1) the ability to retrieve a plurality of desired information listings from the Internet corresponding to each of the plurality of recipients wherein the plurality of desired information listings includes data indicative of information desired by the recipient and (2) a plurality of telephone identification listings corresponding to the plurality of recipients, and a telephone link through which the plurality of recipients can initiate telephone calls to access the process server wherein the process server uses the plurality of telephone identification listings to identify a recipient upon the recipient initiating a telephone call to the telephone link and, in response to identifying the recipient, the process server initiates a process whereby the desired information is provided to the recipient.

In one embodiment, the process server identifies the recipient user caller ID so that the recipient is identified in a manner that reduces the telephone charges incurred by the recipient when requesting information from the server. The system further comprises an information transfer link though which the process server can send the desired information to the recipient via a text messaging service so that, upon the recipient initiating the telephone call to the process server, the process server initiates a process whereby the desired information for the recipient is provided to the recipient in a text format via a pager or cellular telephone interface. The system also comprises an interactive data access device that the process server can access in response to receiving a telephone call from the recipient such that the process server can obtain the desired information for the recipient.

In another aspect, the invention is a method of providing information to a remotely located, portable communication device comprising: correlating at least one information unit represented by a text message maintained by a database system with a first phone number of a retrieval system and a second phone number of the remotely located, portable communication device; calling the first phone number with the remotely located, portable communication device of the second phone number wherein the information retrieval system at the first phone number identifies the calling remotely located, portable communication device by the second phone number; terminating the call to the first phone number substantially immediately after establishing communication; retrieving the information unit from the database system with the information retrieval system; and providing the information to the remotely located, portable communication device at the second phone number.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

Features and advantages of the present invention will become apparent to those skilled in the art from the following description with reference to the drawings, in which:

FIG. 1 is a high-level flow chart illustrating an embodiment of the process by which an information retrieval system sends information to a user and how the information is requested by the user;

FIG. 2 is a system block diagram illustrating one embodiment of the overall network architecture;

FIG. 3 is a flow chart illustrating in greater detail one embodiment of the method of the information retrieval system;

FIG. 4 is a block diagram illustrating one embodiment of certain component of the wireless server system; and

FIG. 5 is a block diagram illustrating retrieval profiles.

### DETAILED DESCRIPTION OF ILLUSTRATIVE EMBODIMENTS

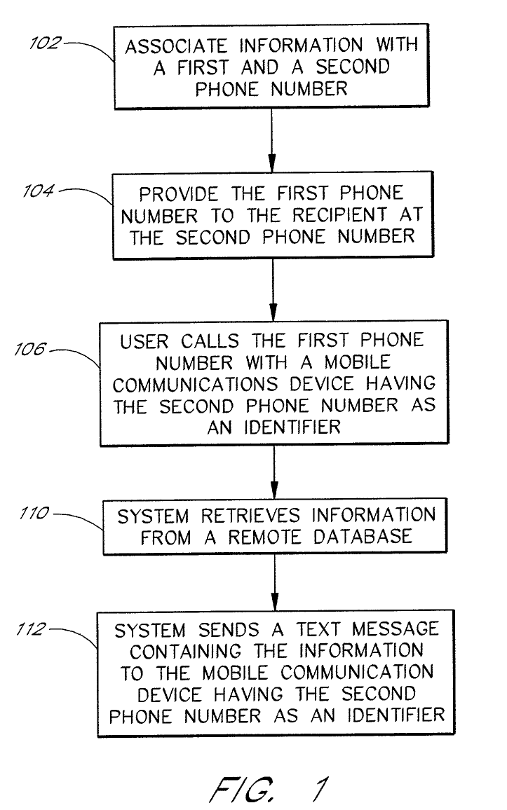

FIG. 1 is a high-level flow chart illustrating one embodiment of the overall operation of the information retrieval system 100. In particular, FIG. 1 illustrates a process by which a mobile recipient requests information and the information retrieval system 100 retrieves the information from a content server and provides the information to the recipient as a text message. As will be described in greater detail below, the information retrieval system 100 allows a user with a remote communications device, such as a cellular telephone, to call a designated first number. Upon the user calling the designated first number, the system 100 identifies the user and provides information to the user as a result of the user initiating the telephone call. The system 100 in one embodiment, associates the information with a second telephone number, preferably the number of the user's remote communications device such that when the system detects the user has called using the remote communications device, the system 100 initiates a process whereby the associated information is provided to the second telephone number.

More specifically, beginning in state 102, the information retrieval system 100 associates a first identifier with an information unit. In this embodiment, the identifier comprises one of a listing of first phone numbers maintained by the information retrieval system 100. The first phone number is a number that the recipient will call via the recipient's remote communications device to request subsequent transmission of the information unit. The information unit comprises the content of at least part of a specified web page and can comprise any of a number of different types of information including stock quotes, weather reports, traffic reports and the like. The information retrieval system 100 also associates the information unit with a second phone number which, in this embodiment, belongs to a recipient's mobile communication device.

The information retrieval system 100 then sends a message containing the first phone number in state 104 to the recipient. The first phone number may be sent as part of a text message, alphanumeric page, or short message system. Hence, the recipient is provided with the telephone number that they can call to request delivery of the information unit.

Subsequently, in state 106, the recipient calls the information retrieval system 100 at the first phone number. In this embodiment, the recipient terminates the call substantially immediately after establishing communication with the first phone number, which, in this embodiment, comprises hanging up after the first or second phone ring. The information retrieval system 100 employs a known caller ID procedure to establish the identity of the calling recipient of the second phone number. It will be appreciated by one skilled in the art that the caller ID procedure occurs before the communication link between the mobile communication device and the information retrieval system 100 is fully established. Thus, in this embodiment, the recipient avoids incurring airtime charges for the use of their mobile communications device in calling the information retrieval system 100, while still enabling the information retrieval system 100 to determine the identity of the recipient and the information desired.

The information retrieval system 100 then retrieves the information in state 110 from the specified Web page in a manner that will be described in greater detail below. The information retrieval system 100 then provides, in state 112, the information corresponding to the recipient identified in state 106. In this embodiment, the information retrieval system 100 transmits a text message containing the information to the mobile communications device. The text message comprises a short messaging service or an alphanumeric page which is sent to the recipient at the second phone number at no incremental cost to the recipient. Thus, providing information via the information retrieval system 100 to the recipient also incurs no marginal expense for the recipient.

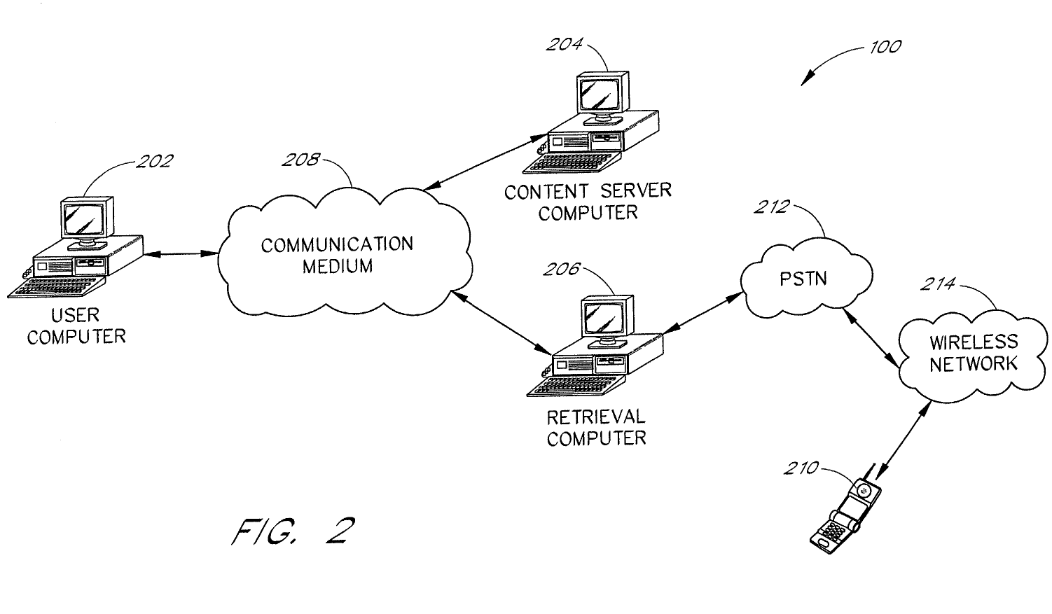

One network architecture suitable for use with one embodiment of the invention is indicated generally by the information retrieval system 100 in FIG. 2. The information retrieval system 100 includes at least one user computer 202, at least one content server computer 204, and a retrieval system computer 206 which communicate with each other through a communication medium 208. Moreover, the retrieval system computer 206 communicates with mobile communication devices 210 utilizing a publicly switched telephone network (PSTN) 212 and a wireless network 214.

A computer, including the computers 202, 204, and 206, may be any computing device that permits access to the communication medium 208, including terminal devices, such as personal computers, workstations, servers, mini computers, main-frame computers, laptop computers, a network of individual computers, mobile computers, palm top computers, hand held computers, set top box for a TV, an interactive television, an interactive kiosk, a personal digital assistant, an interactive wireless communications device, or a combination thereof. The computers may further possess input devices such as a keyboard or a mouse, and output devices such as a computer screen or a speaker. Furthermore, the computers may serve as clients, servers, or a combination thereof.

These computers may be uniprocessor or multiprocessor machines. Additionally, these computers include an addressable storage medium or computer accessible medium, such as random access memory (RAM), an electronically erasable programmable read-only memory (EEPROM), programmable read-only memory (PROM), erasable programmable read-only memory (EPROM), hard disks, floppy disks, laser disk players, digital video devices, compact disks, video tapes, audio tapes, magnetic recording tracks, electronic networks, and other techniques to transmit or store electronic content such as, by way of example, programs and data. In one preferred embodiment, the computers are equipped with a network communication device such as a network interface card, a modem, or other network connection device suitable for connecting to the communication medium 208.

Furthermore, the computers execute an appropriate operating system such as Unix, Microsoft® Windows® 3.1, Microsoft® Windows® 95, Microsoft® Windows® N98 Microsoft® Windows® NT, Apple® MacOS®, LINIX, IRIX, Solaris, or IBM® OS/2®. As is conventional, the appropriate operating system includes a communications protocol implementation which handles all incoming and outgoing message traffic passed over the communication medium 208. In other embodiments, while the operating system may differ depending on the type of computer, the operating system will continue to provide the appropriate communications protocols necessary to establish communication links with the communication medium 208.

The computers may advantageously contain program logic, or other substrate configuration representing data and instructions, which cause the computer to operate in a specific and predefined manner as described herein. In one embodiment, the program logic may advantageously be implemented as one or more modules. The modules may advantageously be configured to reside on the addressable storage medium and configured to execute on one or more processors. The modules include, but are not limited to, software or hardware components which perform certain tasks. Thus, a module may include, by way of example, software components, object-oriented software components, class components and task components, processes, methods, functions, attributes, procedures, subroutines, segments of program code, drivers, firmware, microcode, circuitry, data, databases, data structures, tables, arrays, and variables.

The communication medium 208 advantageously facilitates the transfer of electronic content. In one embodiment, the communication medium 208 includes the Internet. The Internet is a global network comprising millions of interconnected computers. The structure of the Internet, which is well known to those of ordinary skill in the art, is a global network of computer networks utilizing a simple, standard common addressing system and communications protocol called Transmission Control Protocol/Internet Protocol (TCP/IP). The connections between different networks are called “gateways” and the gateways serve to transfer electronic data worldwide.

One part of the Internet is the World Wide Web (WWW) or simply Web. The WWW generally refers to both (1) a distributed collection of interlinked, user-viewable hypertext documents (commonly referred to as “web documents” or “web pages” or “electronic pages” or “home pages”) that are accessible via the Internet, and (2) the client and server software components which provide users access to such documents using standardized Internet protocols. Web documents are typically encoded using Hypertext Markup Language (HTML) and the primary standard protocol for allowing applications to locate and acquire web documents is the Hypertext Transfer Protocol (HTTP). However, as used herein, the term WWW is intended to encompass future markup languages and transport protocols which may be used in place of, or in addition to, HTML and HTTP.

The WWW contains different computers which store electronic Web pages, such as HTML documents, capable of displaying graphical and textual information. The content server computer 204 which provides information and services, such as, by way of example, e-mail services, stock pricing reports, auction services, and travel reservation services, on the WWW is generally referred to as a “web site.” A web site is defined by an Internet address, and the Internet address has an associated electronic page. The electronic page is advantageously associated with a Uniform Resource Locator (“URL”). Generally, an electronic page may advantageously be a document which organizes the presentation of text, graphical images, audio, and video.

One of ordinary skill in the art will recognize that the communication medium 208 may advantageously be comprised of other types of networks without detracting from the scope of the invention. The communication medium 208 can include, by way of example, local area networks (LANs), wide area networks (WANs), public internets, private intranets, a private computer network, a secure internet, a private network, a public network, a value-added network, interactive television networks, wireless data transmission networks, two-way cable networks, interactive kiosk networks, and the like.

The PSTN 212 and the wireless network 214 are known to those of ordinary skill in the art as networks which facilitate both data and voice communications. The PSTN 212 and the wireless network 214 include one or more computers and other communication infrastructure such as, by way of example, telephone switches and routers. One example of the wireless network 214 is a web of cell sites connected to and controlled by a Mobile Telephone Switching Office (otherwise known as a Mobile Switching Center). One example of the PSTN 212 is the Plain Old Telephone Service.

In one embodiment, a mobile recipient utilizes his user computer 202 to access the content server computer 204 through the communication medium 208. For example, the recipient executes a software application comprising a web browser on the user computer 202 to enter and browse a web site residing on the content server computer 204. The browser is a software program which allows a user to access different computers, including web sites and the web pages and documents contained in the web sites, accessible over the WWW and the Internet. In one preferred embodiment, the browser may be a standard browser such as the Netscape® Navigator developed by Netscape, Inc. or the Microsoft®) Internet Explorer developed by Microsoft Corporation. One of ordinary skill in the art will realize that other types of access software could also be used to implement the browser. The other types of access software could be, by way of example, other types of Internet browsers, custom network browsers, communications software, cable modem software, point-to-point software, custom emulation programs, and the like. The information provided by the content server computer 204 preferably includes one or more information offering components which may include e-mail, auctions, e-commerce, financial services, weather reports, stock quotes, and the like. For example, the content server computer 204 may include a current on-line auction pricing for a laptop computer.

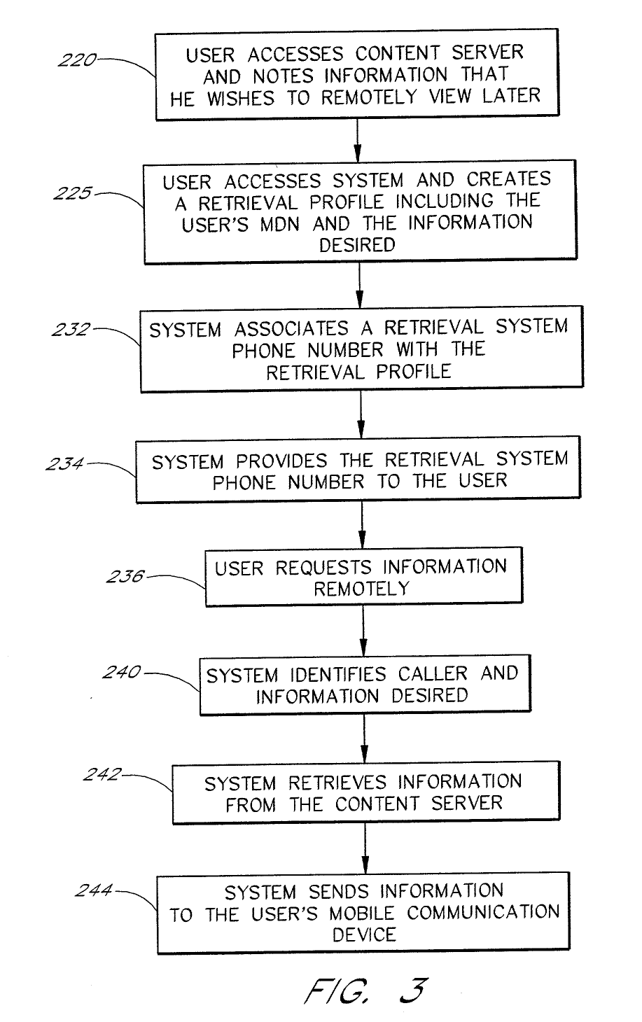

FIG. 3 illustrates in greater detail one embodiment of a method of employing the information retrieval system 100 using the online notebook computer auction as an explanatory vehicle. The recipient, interested in purchasing the notebook computer, accesses a web site maintained by the content server computer 204 with his user computer 202 in state 220 in order to register and participate in the auction. The recipient submits the appropriate user identification information and a bid of $500 for the notebook computer. During the access of the web site of state 220, the recipient notes information 222 that the user wishes to remotely retrieve at later times. In this explanatory example for this embodiment, the information 222 comprises the current bid for the notebook computer. It should be understood that the particular example of the information 222 herein described is simply explanatory and the information 222 may further comprise, but is not limited to, stock pricing reports, weather reports, travel vehicle departure schedules, and other types of information 222 that are available on content server computers 204 in alternative embodiments as will be appreciated by those of skill in the art.

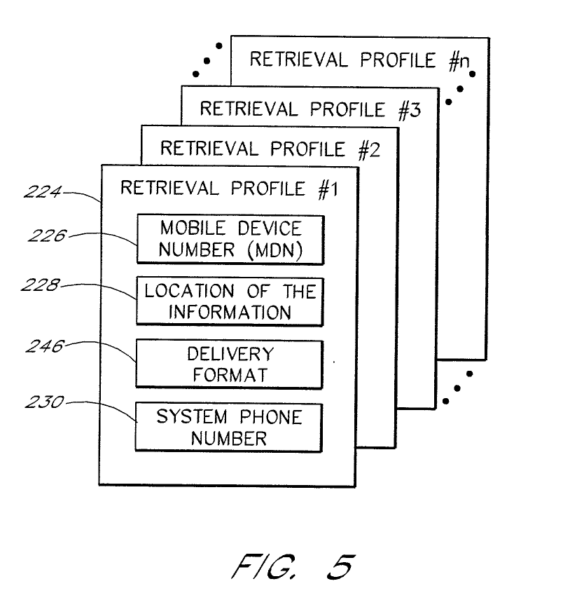

After determining the information 222 that the recipient wishes to retrieve at a later time, the recipient accesses the information retrieval system 100 and, in one embodiment, a web site maintained by the retrieval system computer 206. In this embodiment, a registration component executing in the retrieval system computer 206 requests and processes user submitted identification information and creates a corresponding retrieval profile 224 for the recipient as illustrated in FIG. 5 in state 225. The retrieval profile 224 comprises information such as, by way of example, the user's mobile communication device 210 mobile device number (MDN) 226. The retrieval profile 224 also includes a format 246 for the information 222 which is to be forwarded to the user's mobile communication device 210. The format 246 comprises instructions for how the information 222 is to be presented by the information retrieval system 100, for example, as voice or a text message. The retrieval profile 224 also includes a location 228 of the information 222. In this embodiment, the location 228 is the URL of the information 222 as located at the content server computer 204. The retrieval profile 224 further comprises a system phone number 230. The system phone number 230, in this embodiment, is the phone number that the information retrieval system 100 assigns for the particular unit of information 222 and the system phone number 230 is selected from a listing of phone numbers previously provided for the information retrieval system 100. It will be appreciated that a different system phone number 230 is assigned for each unit of information 222 that a recipient wishes to receive, however that a plurality of different recipients can be assigned the same system phone number 230.

As shown in FIG. 3, then the information retrieval system 100 provides the system phone number 230 to the recipient in state 234. In one embodiment, providing the system phone number 230 in state 234 occurs substantially immediately following the completion of creating the retrieval profile 224 by presenting the system phone number 230 as a text field on the web site maintained by the retrieval system computer 206. In another embodiment, the retrieval system computer 206 sends the system phone number 230 to the recipient's mobile communication device 210 in state 234 in a manner that will be described in greater detail below. The retrieval system phone number 230 provides a vehicle for the recipient to retrieve the information 222 in a manner that will be described in greater detail below. It should be appreciated that a different retrieval system phone number is provided for each different retrieval profile 224 and the associated information 222 that a particular recipient establishes.

Continuing the auction example, the user wishes to check for any subsequent higher bids for the notebook computer. The information retrieval system 100 advantageously coordinates between the retrieval system computer 206 and the various content server computers 204 such that the information 222 can be readily retrieved by the retrieval system computer 206 from the content server computers 204 via the communication medium 208 in the format 246, such as a text message, defined in the retrieval profile 224. The information 222 can then be readily sent to the recipient in a manner that will be described in greater detail below. Continuing the auction example, the content server computer 204 receives a subsequent higher bid of $510 from a second bidder and updates the information 222 to reflect the current bid price of $510. Those of ordinary skill in the art will realize that the content server computer 204 continues to perform the other functions associated with the auction event in order to properly administer the auction.

After the recipient has received the system phone number 230, the recipient can request retrieval of the information 222 in state 236. The recipient calls the associated system phone number 230 with his mobile communication device 210. The retrieval system computer 206 employs a known caller ID procedure to identify which particular recipient is calling and, in combination with the system phone number 230 which was called, establishes, in state 240, the unique retrieval profile 224 for the information 222 desired and to whom the information 222 should be provided. Since the retrieval profile 224 already includes the MDN 226 of the recipient and the information 222 which the recipient has already requested to retrieve, the recipient does not need to provide any additional information other than notifying the information retrieval system 100 that he wishes to retrieve the information 222.

In this embodiment, the recipient terminates the phone call to the system phone number 230 once the information retrieval system 100 has established the identity of the calling recipient. In this embodiment, establishing the identity of the calling recipient and terminating the call occurs by the first ring of the mobile communication device 210 and before the second ring. By terminating the call after the first ring and before the second ring, the recipient avoids incurring airtime charges for the use of the mobile communication device 210.

While in this embodiment, the system 100 preferably identifies the caller between the first and the second ring, it will be appreciated that the system 100 can be configured to not answer any incoming telephone calls to the first phone number. Caller ID systems work by identifying the incoming call prior to the call being completed. By not picking up the incoming call, the system 100 can have a longer period of time to identify the caller. In telephony systems where airtime or other phone charges are only incurred when a telephone call is completed, the system 100 can thus have more time to identify the caller without actually having the caller incur telephone charges.

Receiving a call to the system phone number 230 induces, in state 242, the information retrieval system 100 and, in particular, the retrieval system computer 206 to contact the corresponding content server computer 204 at the corresponding location (URL) 228 via the communication medium 208 in a known manner and extract the indicated information 222 from the content server computer 204. Once the information retrieval system 100 has extracted the information 222 from the content server computer 204, the information retrieval system 100 sends, in state 244, the information 222 to the recipient in accordance with the format 246 defined in the retrieval profile 224. In this embodiment, providing the information 222 to the recipient comprises sending a text message containing the information 222 to the recipient's mobile communication device 210 in a manner that will be described in greater detail below. In this embodiment, sending a text message to the recipient's mobile communication device 210 in state 244 does not incur airtime charges. Thus, both the request for information 222 of state 236 and the providing of the information 222 of state 244 incur no marginal costs to the recipient.

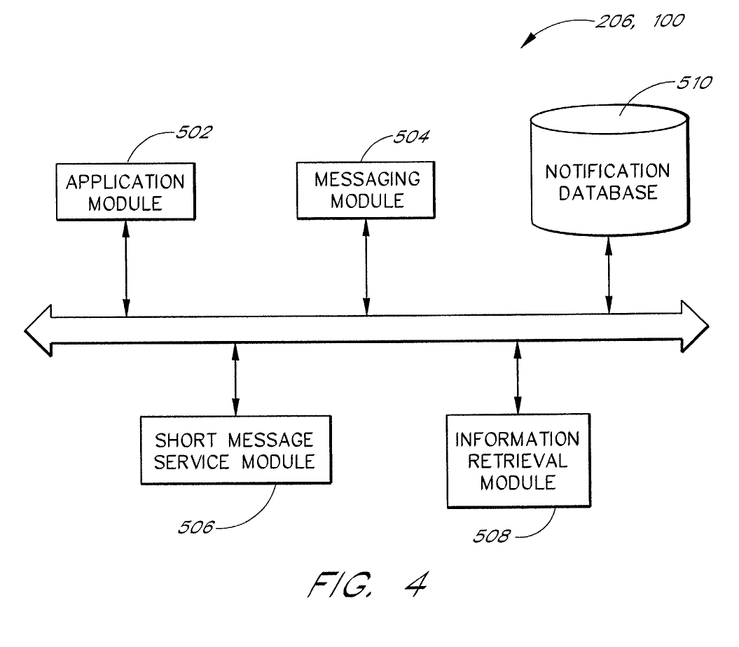

FIG. 4 is a block diagram illustrating one embodiment of certain components of the information retrieval system 100. The information retrieval system 100 includes an application module 502, a messaging module 504, a short message service module 506, an information retrieval module 508, and a notification database 510. The depicted components may advantageously communicate with each other and other components comprising the respective computers through mechanisms such as, by way of example, interprocess communication, remote procedure call, and other various program interfaces. Furthermore, the functionality provided for in the components, modules, and databases may be combined into fewer components, modules, or databases or further separated into additional components, modules, or databases. Additionally, the components, modules, and databases may advantageously be implemented on one or more computers.

The application module 502 includes one or more software program modules configured to interact with the one or more service applications executing on the content server computer 204. The application module 502 may advantageously extend the web site services offered on the content server computer 204. In one embodiment, the application module 502 advantageously provides access to the one or more retrieval profiles 224 residing on the retrieval system computer 206. Thus, the content server computer 204 may provide users the option of interfacing to and accessing the appropriate retrieval profile 224 which is stored on the retrieval system computer 206. As an example, a first web page on the content server computer 204 may provide access, for example, through a hyper link, to a second web page residing on the retrieval system computer 206. The second web page may facilitate access to and modification of the data stored in a retrieval profile 224.

In another embodiment, the application module 502 may include a registration module which registers one or more users requesting information 222. For example, a service application executing on the content server computer 204 may provide users the option of receiving notification for particular events associated with the service. Subsequent to the user electing the retrieval option, the notification-offering component may advantageously invoke the application module 502 executing on the retrieval system computer 206. In particular, the registration module of the application module 502 facilitates the user registration so that the information retrieval system 100 may properly perform the requested retrieval services previously described. In still another embodiment, the registration module may be configured to execute on the content server computer 204.

The messaging module 504 includes one or more software program modules configured to interact with the one or more service applications executing on the content server computer 204. In one embodiment, the messaging module 504 includes, for example, an information receiving module, an information identification module, and an information summary module. The information receiving module interfaces with and receives information 222 from the content server computer 204. The information 222 may be received by such mechanisms as, by way of example, Simple Mail Transfer Protocol (SMTP), Extensible Markup Language (XML), File Transfer Protocol (FTP), and the like. The information identification module identifies the appropriate retrieval profile 224 for the forwarded information 222, and from the content of the retrieval profile 224, determines if the user requested notification of the forwarded information 222. The event summary module creates a message summary for the information 222 for which the user requested notification.

The short message service module 506 is configured to transmit a short message, typically less than 120 alphanumeric characters, to the mobile communications devices 210. In one embodiment, the short message service module includes a notification module which advantageously transmits the summary message containing the information 222 to the appropriate mobile communications device 210. The wireless notification module may transmit the summary message by, for example, sending an e-mail to the mobile communications device 210, sending an alphanumeric page, implementing dialup and data transmission software, and the like. Those of ordinary skill in the art will realize that the short message service module 506 may advantageously be implemented as an intelligent peripheral that uses ANSI-41 signaling protocol.

The interactive information retrieval module 508 facilitates the access of information 222 contained in a database, such as the notification database 510, from a remote device such as the mobile communications device 210. In one embodiment, the information retrieval module 508 receives and processes a call from the user. The information retrieval module 508 may advantageously receive and process the incoming call, use data from the one or more databases to authenticate the calling user, retrieve the appropriate information 222 message, and read the retrieved information 222 message.

In another embodiment, the information retrieval module 508 may provide the caller with options to perform additional activities in response to receiving the information message. In still another embodiment, the information retrieval module 508 may provide the user access to his or her retrieval profile 224, and permit the user to modify the information contained in the retrieval profile 224. Those of ordinary skill in the art will realize that text-to-speech applications may be incorporated into and used by the information retrieval module 508 in performing its function. Furthermore, the interactive voice response module may incorporate one or more scripts and stored messages. The scripts may include logic which determines how and what information 222 is provided to the calling user and the type of information, either keypad or voice, which the user may enter using the mobile communications device 210 or other voice or data transmission mechanism.

The notification database 510 contains portions of the information 222 and other data maintained by the information retrieval system 100. The notification database 510 contains, for example, the retrieval profiles 224, the message database, and any other information necessary to perform the retrieval function as previously described. Those of ordinary skill in the art will realize that the notification database 510 may be comprised of one or more databases, and the databases may reside on one or more computers. Furthermore, it is appreciated by those of ordinary skill in the art that the functionality of the components and modules disclosed herein may be combined into fewer components and modules or separated into additional components and modules.

While the invention has been described with reference to the exemplary embodiments thereof, those skilled in the art will be able to make various modifications to the described embodiments of the invention without departing from the true spirit and scope of the invention.

What is claimed is:

1. A system for delivering information to a plurality of mobile recipients having mobile communications devices capable of receiving text messages, said system comprising:
at least one process server;
at least one memory comprising:
a plurality of desired information listings corresponding to each of a plurality of recipients, said plurality of desired information listings including data indicative of information desired by each respective one of said plurality of recipients, and
a plurality of telephone identification listings corresponding to said plurality of recipients; and
a telephone link through which said plurality of recipients can initiate telephone calls to access said process server;
wherein said process server uses said plurality of telephone identification listings to identify a recipient upon said recipient initiating a telephone call to said telephone link; and
in response to identifying said recipient, said process server initiates a process whereby said desired information is provided to said recipient.

2. The system for delivering information to a plurality of mobile recipients having mobile communications devices capable of receiving text messages according to claim 1, wherein:
said process server identifies a caller ID of said recipient to identify said recipient in a manner that reduces telephone charges otherwise incurred by said recipient in calling said telephone link.

3. The system for delivering information to a plurality of mobile recipients having mobile communications devices capable of receiving text messages according to claim 1, further comprising:
an information transfer link though which said process server can send said desired information to said recipient.

4. The system for delivering information to a plurality of mobile recipients having mobile communications devices capable of receiving text messages according to claim 1, wherein said information transfer link comprises:
a text messaging service associated with said process server to provide desired information for said recipient to said recipient in a text format upon initiation of a telephone call by said recipient to said telephone link.

5. The system for delivering information to a plurality of mobile recipients having mobile communications devices capable of receiving text messages according to claim 4, wherein said text messaging services comprises:
a text messaging service that permits delivery of text messages to said recipient via at least one of a pager and a cellular telephone.

6. The system for delivering information to a plurality of mobile recipients having mobile communications devices capable of receiving text messages according to claim 1, further comprising:
an interactive data access device that said process server may access in response to receipt of a telephone call from said recipient such that said process server can obtain desired information for said recipient.

7. A method of providing electronic mail notification to a communications device, comprising:
associating an electronic mail account with a first phone number;
calling said first phone number from a communications device; and
providing said electronic mail message to said communications device after said communications device calls the first phone number.

8. The method of providing electronic mail notification to a communications device according to claim 7, further comprising:
obtaining a communications device identifier when said communications device dials said first phone number; and
using said communications device identifier to select said electronic mail message.

9. A method of providing information to a remotely located, portable communication device, comprising:
correlating at least one information unit represented by a text message maintained by a database system with a first phone number of an information retrieval system and a second phone number of a remotely located, portable communication device;
calling said first phone number with said remotely located, portable communication device, wherein said information retrieval system having said first phone number identifies said portable communication device using said second phone number;
establishing and terminating said call to said first phone number;
retrieving said at least one information unit from said database system using said information retrieval system; and
providing said information to said portable communication device using said second phone number.

10. The method of providing information to a remotely located, portable communication device according to claim 9, wherein said portable communication device comprises:
a text messaging capable cellular telephone.

11. The method of providing information to a remotely located, portable communication device according to claim 9, wherein identification of said portable communication device includes:
utilization of caller ID information.

12. The method of providing information to a remotely located, portable communication device according to claim 9, wherein:
termination of said call to said first phone number is performed after a first ring.

13. The method of providing information to a remotely located, portable communication device according to claim 9, wherein:
each instance of providing information to said portable communication device incurs no marginal cost to a user of said portable communication device.

14. The method of providing information to a remotely located, portable communication device according to claim 9, wherein:
providing information to said portable communication device from said database system via said information retrieval system occurs only once in response to each incidence of calling said first phone number from said portable communication device.

15. A method of providing database access, comprising:
associating a first piece of information with a first communications device identifier in a system;
detecting a first communications device identifier when said first communications device is used to contact said system;
retrieving said first piece of information in response to detection of said first communications device identifier; and
transmitting said first piece of information to said first communications device following retrieval of said first piece of information.

16. The method of providing database access according to claim 15, wherein:
said first piece of information is associated with said first communications device identifier by designating a first piece of information as information that is to be transmitted to a telephone number assigned to said first communications device.

17. The method of providing database access according to claim 16, wherein said designation of said first piece of information as information that is to be transmitted to a telephone number assigned to said first communications device comprises:
designating a selected stock quotation to be transmitted to said first communications device.

18. The method of providing database access according to claim 16, wherein said designation of said first piece of information as information that is to be transmitted to a telephone number assigned to said first communications device comprises:
designating a selected traffic report that is to be transmitted to said first communications device.

19. The method of providing database access according to claim 16, wherein said detection of said first communications device identifier comprises:
identifying said telephone number of said first communications device when said first communication device contacts said system via telephony.

20. The method of providing database access according to claim 19, wherein said identification of said telephone number of said first communications device comprises:
using caller ID to identify said first communications device prior to a telephone connection being established between said communications device and said system.

21. The method of providing database access according to claim 19, wherein said transmission of said first piece of information to said first communications device comprises:
sending a text message to said first communications device using said telephone number of said first communications device.
